(19) United States
(12) Patent Application Publication
(10) Pub. No.: US 2004/0185258 A1
(43) Pub. Date: Sep. 23, 2004

(54) Electron beam-bonded multilayer laminated body and process for its production

(76) Inventors: Tatsuo Fukushi, Woodbury, MN (US); Keizo Yamanaka, Minnesota, MN (US)

Correspondence Address: 3M INNOVATIVE PROPERTIES COMPANY, PO BOX 33427, ST. PAUL, MN, 55133-3427, US

(21) Appl. No.: 10/483,874

(22) PCT Filed: Jun. 24, 2002
(86) PCT No.: PCT/US02/19950

(30) Foreign Application Priority Data
Aug. 13, 2001 (JP) 2001-245709

(51) Int. Cl. B32B 9/04

(52) U.S. Cl. 428/412; 428/447; 428/480; 428/500

(57) ABSTRACT

To provide a process for imparting sufficient bonding between resin sheets of multilayer sheets, by a more simple process. SOLUTION MEANS A multilayer laminated body comprising three or more laminated layers of resin sheets made of at least two different materials, the multilayer laminated body being characterized by having chemical bonding formed between the three or more layers by electron beam radiation. The number of layers of the multilayer film may be a few hundred or more.

### DETAILED DESCRIPTION OF THE INVENTION

1. Technical Field of the Invention

The present invention relates to a multilayer laminated body comprising three or more laminated resin sheets and to a process for its production, and more specifically it relates to a multilayer laminated body wherein the layers are bonded together by electron beam radiation and to a process for its production, the multilayer laminated body being useful as a multilayer optical sheet.

2. Prior Art

Optical interference filters which reflect light at high efficiency due to their multilayer structures of resin films with different refractive indexes are known. Prior research on reflection of light from multilayered resin films may be found in Alfrey et al., Polymer Engineering and Science, Vol.9, No.6, pp.400-404, 1964, Radford et al., Polymer Engineering and Science, Vol.13, No.3, pp.216-221, etc.

For example, laminated bodies of approximately 500 layers prepared by alternating lamination of resins with different refractive indexes (polyesters, polycarbonates, acrylic polymers, etc.), having layer thicknesses selected for ¼ wavelength, can exhibit an average reflectivity of about 99% in the total visible light range. The orientation of the resin films of the laminated body can be utilized to achieve a polarizer structure. The thickness of each layer (resin film) in such multilayer structures may be, for example, approximately a few hundred nanometers.

Such multilayer optical sheets are produced by multilayer melt extrusion of the necessary number of layers of two types of thermoplastic resins with different refractive indexes, and rapid drawing thereof (for example, U.S. Pat. No. 3,773,882, U.S. Pat. No. 3,195,865, etc.). As a typical example, molten resins are collected in a feed block from two, three or more extruders, forming therein a flow of a multilayer structure with the resins alternately repeating, for example, a multilayer structure of 2 layers (ABABAB . . . ) or 3 layers (ABCABC . . . ), and after extrusion thereof with an ordinary single manifold flat film die while simultaneously adjusting the die width, the exiting multilayer sheet is rapidly drawn to produce a multilayer optical sheet.

With multilayer optical sheets which are laminated bodies of multiple resin films produced by the method described above, there is no substantial bonding between the melt extruded and stretched multilayer resin films. It can occur, of course, that some diffusion of resin components between the multilayer resin films during post-extrusion stretching and then cooling of the molten resins results in formation of weak bonding between the multilayer resin films. However, this bonding does not provide sufficient adhesion, and therefore changes in humidity or environmental temperature or mechanical action during handling cause peeling between the resin films or bulging in the multilayer optical sheet, which can raise the possibility of deterioration of the properties of the multilayer optical sheet.

Fluorine-containing materials or polyolefin-based materials are sometimes preferred for use as resin films for constitution of multilayer optical sheets. These materials have low surface energy and low adhesion with other resins, and do not form adhesion in multilayer resin films during production by extrusion and stretching. Consequently, it has been essentially impossible to avoid peeling between the resin films or bulging in the multilayer optical sheet caused by changes in environmental humidity or temperature during use of multilayer optical sheets or mechanical action during handling.

When such a multilayer optical sheet is actually incorporated into a device, a device construction is adopted which minimizes peeling between the three or more layers of resin films. However, the possibility of peeling between resin films due to the conditions of use still remains. It has therefore been desirable to provide sufficient bonding between resin films of such multilayer resin sheets.

Situations in which bonding is desired between resin films of multilayer laminated sheets are not limited to multilayer optical films, but also include cases where a plurality of resin films with different properties other than optical properties are laminated to construct other functional materials.

It is therefore an object of the present invention to provide a multilayer laminated body with chemical bonding between layers of a laminated body prepared by laminating resin sheets made of two or more different materials, as well as a process for its production.

The following explanation concerns references that may be relevant to the present invention relating to formation of chemical bonding between multilayer resin films by electron beam radiation.

Improvement of heat resistance by crosslinking of polymers such as polyethylene using electron beam radiation is well known. Relevant descriptions may be found, for example, in “Modern fluoropolymers”, edited by John Scheirs, John Wiley & Sons, New York (1997). Also, in Makuuchi et al., J. Poly. Sci. Poly. Chem. Ed., 14, 617-625 (1976) it is suggested that electron beam radiation of PVdF generates radicals that form a crosslinking structure.

On the other hand, electron beam radiation is also known as a means of crosslinking adhesives. In U.S. Pat. No. 2,956,904, Hendriks reports crosslinking of rubber-based adhesives by electron beam radiation.

In U.S. Pat. No. 5,209,971, Babu et al. disclose improvement in cohesive force and heat resistance by irradiation of a polyolefin-based adhesive with an electron beam to cause crosslinking of the adhesive.

In U.S. Pat. No. 4,563,388, Bonk et al. report improvement in adhesion -at interfaces by irradiation of an electron beam onto an acrylic-based adhesive applied to a polyolefin-based film material. Similarly, in Japanese Unexamined Patent Publication SHO No. 63-150330 there is disclosed by Mori et al. a method of improving adhesion between a polyolefin and acrylic material by electron beam radiation onto a polyolefin film and metal sheet laminated via an acrylic monomer. In Example 8 of U.S. Pat. No. 3,252,880, Magat et al. demonstrate that immersion of a PTFE (polytetrafluoroethylene) sheet in an acrylic monomer and exposure to γ-rays for 3 days causes grafting of acrylonitrile polymer to the PTFE sheet surface, thus creating tack on the surface. However, the Tg of polyacrylonitrile alone is approximately 100° C., and therefore it is not effective as an adhesive.

Toray Co. has disclosed a class of inventions using fluorine-containing resin films as base materials, and notable among them is Japanese Unexamined Patent Publication HEI No. 10-58617 which discloses a mending sheet having an antifouling layer on one side of a fluorine resin film and an adhesive layer on the other side. The adhesion between the fluorine resin film and the antifouling and adhesive layers is promoted by surface treatment or primary coat treatment. An ultraviolet absorbing layer is provided between the fluorine resin film and the adhesive layer, and addition of a crosslinking agent to the ultraviolet absorbing layer allows crosslinking by heat, ultraviolet radiation or electron beam radiation. However, the adhesion between the fluorine resin film and the ultraviolet absorbing layer is promoted by surface treatment or primary coat treatment.

Incidentally, Japanese Unexamined Patent Publication HEI No. 4-146129 describes a fluorine-containing resin film which has a printing layer formed by an ink resin composition on the surface of a metal whereby thermal bonding forms a resin-coated metal, for which reason the ink resin composition is composed of an energy beam-curing resin. The printing layer is only partially printed on the fluorine-containing resin film, and the fluorine-containing resin film is thermally bonded to the metal surface. The fluorine-containing resin film is thermally bonded to the metal base material and there is no adhesion between the resin films of the multilayer sheet.

Also, Japanese Unexamined Patent Publication HEI No. 5-8353 proposes using radiation crosslinking to introduce a crosslinked structure into a resin tube having a polyamide resin outer layer and a fluorine-containing resin inner layer, as a resin tube suitable for vehicle fuel tubing and the like. This is a double-extruded resin product, and thus differs from the present invention which is a multilayer laminated sheet prepared by lamination of a plurality of resin films.

Given these circumstances of the prior art, it has been a goal to provide a process for imparting sufficient bonding between resin sheets of multilayer sheets, by a more simple process.

Means for Solving the Problems

In order to solve these problems, the present invention provides the following.

(1) A multilayer laminated body comprising three or more layers, preferably five or more layers, more preferably ten or more layers and especially 40 or more layers of laminated resin sheets made of at least two different materials, the multilayer laminated body being characterized by having chemical bonding formed between the layers of resin sheets by electron beam radiation.

(2) A multilayer laminated body according to (1) above, wherein at least one of said resin sheet is a resin sheet of a material having a low surface energy of not more than 45 mJ/m².

(3) A multilayer laminated body according to (1) above, wherein at least one of the resin sheets is a fluorine-containing material sheet.

(4) A multilayer laminated body according to (1) to (3) above, wherein at least one of said resin sheet is a silicone resin sheet.

(5) A multilayer laminated body according to (1) or (2) above, wherein at least one of the resin sheets is a sheet made of at least one type of resin selected from the group consisting of polyolefin-based resins, polycarbonate resins, polyester resins, urethane resins and acrylic resins.

(6) A multilayer laminated body according to any of (1) to (3) above, wherein the laminated body is an optical sheet formed by laminating resin sheets with at least two different refractive indexes.

(7) A multilayer laminated body according to (4), wherein the optical sheet is a reflective sheet, non-reflective sheet or polarizing sheet.

(8) A process for production of a multilayer laminated body, characterized by radiating an electron beam onto a laminated body comprising three or more laminated layers of resin sheets made of at least two different materials, to form chemical bonds between the three or more layers.

### PREFERRED EMBODIMENTS OF THE INVENTION

The multilayer laminated body of the invention is a laminated body comprising three or more layers, preferably ten or more layers and especially 40 or more layers of laminated resin sheets made of at least two different materials.

The multilayer laminated body of the invention, wherein the constitutive resin sheets are made of at least two different materials, provides multiple layers of these resin sheets of different materials to exhibit a composite function that cannot be achieved by single resin sheets. The resins of different materials are typically resins with different optical properties, and especially refractive index, which are laminated into a multilayer optical sheet, but this is not necessarily limited to optical properties. For example, resin sheets with different physical permeability may be laminated to fabricate a multilayer laminated body exhibiting multiple functions.

The multilayer laminated body of the invention is a laminated body prepared by laminating three or more layers, preferably ten or more layers and especially 40 or more layers of resin sheets. For a multilayer optical sheet, usually 40 or more layers, and even from 100 to 400 layers, of resin sheets are laminated to form a reflective sheet or the like but, depending on the function, the multilayer laminated body may have three or more layers or approximately ten layers.

Electron beam radiation of such a multilayer laminated body to form chemical bonding between the resin sheets constituting the multilayer laminated body has been unknown in the prior art.

The thickness of the resin sheets constituting the multilayer laminated body of the invention may be set to λ/4 for the optical thickness of each adjacent high refractive index layer and low refractive index layer, for an interference effect. In order to obtain reflection in the total visible light region of 400-750 nm, the optical thickness of the film is adjustable by about 40-200 nm, considering the incident angle, to obtain satisfactory reflection. Alternatively, a similar construction may be used to fabricate a multilayer laminated body which selectively transmits only a specific wavelength range while substantially blocking other wavelength ranges, for use as an optical filter.

In light of the circumstances described above, the present invention may be effectively applied in cases where each resin sheet of the multilayer laminated body is of a material with no adhesion to adjacent resin sheets, or in cases where, for example, each resin sheet is of a material with adhesion with the other resin sheets but sufficient adhesion cannot be achieved between each of the resin sheets during production of the multilayer laminated body due to restrictions inherent in the production process for the multilayer laminated body. That is, the invention may be applied for all laminated bodies prepared by laminating three or more layers, preferably ten or more layers and especially 40 or more layers of resin sheets made of at least two different types of materials, irrespective of the materials of the resin sheets.

Nevertheless, the present invention is particularly effective in cases where some of the resin sheets constituting the multilayer laminated body are of materials with no adhesion with the other resin sheets, since it represents an indispensable technique.

As low adhesion resins there may be mentioned fluorine-containing materials, silicone-based materials, polyolefin-based materials and the like. The low adhesion resins are resins having a low surface energy, generally not more than 45 mJ/m², further typically not more than 40 mJ/m² or not more than 35 mJ/m2.

Fluorine-Based Materials

Fluorine-based materials (specifically, fluorine-containing materials and fluorinated materials) to be used as resin sheets for the multilayer laminated body of the invention include, for example, fluorocarbon simple monomers, copolymers and their (mutual) blends or blends with non-fluorine-based materials.

Useful fluorine-containing monomers include hexafluoropropylene (HFP), tetrafluoroethylene (TFE), vinylidene fluoride (VdF), vinyl fluoride (VF), chlorotrifluoroethylene (CTFE), 2-chloropentafluoropropylene and perfluoroalkylvinyl ethers, for example, CF₃OCF═CF₂ or CF₃CF₂OCF═CF₂, 1-hydropentafluoropropylene, 2-hydropentafluoropropene, dichlorodifluoroethylene, trifluoroethylene, 1,1-dichlorofluoroethylene, vinyl fluoride and perfluoro-1,3-dioxane (U.S. Pat. No. 4,558,142). Useful fluorine-containing diolefins also exist, for example, perfluorodiallyl ether and perfluoro-1,3-butanediene. These fluorine-containing monomers may also be copolymerized with fluorine-free terminal unsaturated monoolefin comonomers such as ethylene or propylene. The content of the fluorine-containing monomer is preferably at least 50 wt % of the total monomers in the polymer mixture. The fluorine-containing monomer may be copolymerized with an iodine- or bromine-containing curing site monomer to prepare a peroxide-curable polymer. Suitable curing site monomers include terminal unsaturated monoolefins of 2-4 carbons, for example, bromodifluoroethylene, bromotrifluoroethylene, iodotrifluoroethylene and 4-bromo-3,3,4,4-tetrafluorobutene-1.

As mentioned above, fluorocarbon simple monomers, copolymers or mixtures and crosslinked mixtures with other polymers may be used.

As fluorine polymers suitable for use there may be mentioned polymers and copolymers such as, for example, polyvinylidene fluoride (PVdF), polyvinyl fluoride (PVF), tetrafluoroethylene-perfluoroalkyl vinyl ether copolymer (PFA), tetrafluoroethylene-ethylene copolymer (ETFE), tetrafluoroethylene-ethylene-propylene copolymer, tetrafluoroethylene-ethylene-perfluoroalkyl vinyl ether copolymer, tetrafluoroethylene-ethylene-heptafluoropentene copolymer, tetrafluoroethylene-ethylene-(perfluorobutyl)ethylene copolymer, tetrafluoroethylene-ethylene-hexafluoropropylene copolymer, tetrafluoroethylene-propylene copolymer, tetrafluoroethylene-propylene-vinylidene fluoride copolymer, tetrafluoroethylene-hexafluoropropylene copolymer (FEP), tetrafluoroethylene-hexafluoropropylene-perfluoroalkyl vinyl ether copolymer, tetrafluoroethylene-hexafluoropropylene-vinylidene fluoride copolymer (THV), tetrafluoroethylene-hexafluoropropylene-vinylidene fluoride-tetrafluoroiodopropoxytrifluoroethylene copolymer, tetrafluoroethylene-vinylidene fluoride copolymer, chlorotrifluoroethylene-ethylene copolymer, chlorotrifluoroethylene-vinylidene fluoride copolymer, vinylidene fluoride-hexafluoropropylene copolymer and vinylidene fluoride-trifluoroethylene copolymer; there may also be mentioned graft, block and blend polymer copolymers, for example, grafts of chlorotrifluoroethylene-vinylidene fluoride copolymers with vinylidene fluoride copolymer, and block polymers of tetrafluoroethylene-ethylene copolymer and vinylidene fluoride-hexafluoropropylene copolymer.

The following examples may be mentioned as commercially available products thereof.

| | |
|---|---|
| Halar | Chlorotrifluoroethylene-ethylene copolymer |
| | (Allied Corp.) |
| KF Polymer | Polyvinylidene fluoride (Kureha Chemicals) |
| Teflon FEP | Tetrafluoroethylene-hexafluoropropylene |
| | copolymer (E.I. DuPont) |
| Aclon | Chlorotrifluoroethylene-vinylidene fluoride |
| | copolymer (Allied Corp.) |
| KynarFlex 2800 | Vinylidene fluoride-hexafluoropropylene |
| | copolymer (Atochem) |
| THV 220G | Tetrafluoroethylene-hexafluoropropylene- |
| | vinylidene fluoride copolymer (Dyneon) |
| THV 500G | Tetrafluoroethylene-hexafluoropropylene- |
| | vinylidene fluoride copolymer (Dyneon) |
| Aflon COP | Tetrafluoroethylene-ethylene-based copolymer |
| | (Asahi Glass) |
| Cefral Soft | Vinylidene fluoride-based graft polymer |
| | (Central Glass) |
| Daiel T-530 | Hexafluoropropylene-vinylidene fluoride-based |
| | block polymer (Daikin) |
| HTE X1500 | Tetrafluoroethylene-ethylene-based copolymer |
| | (Dyneon) |
| Neoflon EP-610 | Tetrafluoroethylene-ethylene-based copolymer |
| | (Daikin) |
| Aflas 150E | Tetrafluoroethylene-propylene copolymer |
| | (Asahi Glass) |
| Aflas 200 | Tetrafluoroethylene-propylene-vinylidene |
| | fluoride copolymer (Asahi Glass) |
| Teflon PFA | Tetrafluoroethylene-fluoropropyl vinyl ether |
| | copolymer (E.I. DuPont) |
| Tedlar | Polyvinyl fluoride (E.I. DuPont) |
| TFM-1700 | Modified polytetrafluoroethylene |

Fluorine-containing materials constituting fluorine-containing material sheets have excellent chemical resistance, heat resistance, mechanical properties and electrical properties due to the presence of fluorine, and the fluorine content should therefore be at least 10 wt %, more preferably at least 30 wt % and even more preferably at least 40 wt %. The fluorine content may also be 50 wt % or higher, and up to a maximum of 76 wt %. A fluorine-based material sheet is preferably crosslinkable by electron beam radiation. Electron beam-disintegrating materials will require special considerations in regard to the accelerating voltage and linear density of the electron beam, and the irradiation time. For example, polytetrafluoroethylene is a polymer which disintegrates by electron beam radiation, and it is not suitable for the invention. However, polytetrafluoroethylene may still be suitable if it is modified polytetrafluoroethylene with enhanced disintegration resistance. Also, electron beam-disintegrating materials combined with non-electron beam-disintegrating materials or crosslinking materials can avoid impairment of the film by electron beam radiation, and such materials can be used under these irradiation conditions.

Fluorine-containing materials may, if necessary, contain various types of additives such as coloring agents (pigments and dyes), fillers, ultraviolet absorbers and the like.

Other Resin Sheets

The present invention may also be applied to multilayer laminated bodies comprising, for example, silicone-based materials and polyolefin-based materials, as well as acrylate-based, urethane-based, polyester-based, polycarbonate-based and polystyrene-based resins.

Production of Multilayer Laminated Body

The multilayer laminated body of the invention may be prepared by stacking, i.e. laminating, the constitutive resin sheets after their individual fabrication.

However, co-extrusion is preferably used as the production method for a multilayer laminated body of multiple alternating layers of different types of resin sheets. Chill-roll casting, or other methods, may also be employed.

Examples of multilayer laminated bodies As an example, there is disclosed in W095/17303 a multilayer laminated film comprising a plurality of alternating separate resin layers such as a crystalline naphthalene dicarboxylic acid polyester layer and a layer of a different resin such as polyester or polycarbonate, wherein the thickness of each layer is less than 0.5 μm, the refractive index of one resin in one direction is 1.9 while that in the other direction is 1.64, and the multilayer laminated film thereby exhibits a birefringence effect which is useful for polarization.

Examples of optical sheets comprising multilayer laminated films include reflective sheets, non-reflective sheets and polarizing sheets.

The multilayer laminated body of the invention is characterized by using electron beam radiation to form chemical bonding between the resin sheets constituting the multilayer laminated body. With conventional multilayer laminated bodies, there has either been no bonding or else insufficient bonding between the resin sheets.

According to the present invention, however, it has been found that simple electron beam radiation can give a multilayer laminated body with strong chemical bonding formed between the resin sheets. The polymer bonds are broken on the surfaces of the electron beam-irradiated resin sheets (including low energy materials such as fluorine-containing materials) generating radicals, and bonding occurs between the radicals of the adjacent resin sheets, or between the radicals and active sites thereof. This provides adhesion in the multilayer laminated body. When bonding was formed between resin sheets by electron beam radiation according to the invention, substantially no change was observed in the optical properties such as optical transmittance, although some change in properties is permissible.

When such chemical bonding is formed by electron beam radiation between fluorine-containing base material sheets, the structure of the interlayer bonding is different from when chemical bonding is formed by other methods such as adhesive or metal sodium treatment or alkali treatment. The multilayer laminated body of the invention is characterized by having a structure which is based on the technique of electron beam radiation.

According to the invention, the electron beam is irradiated to all of the interfaces of the resin sheets in which it is desired to form bonding for the multilayer laminated body. However, the electron beam does not necessarily have to be irradiated on the entire surface of the multilayer laminated body (each resin sheet), and for example, it may be irradiated in any type of pattern, such as selectively irradiated at the edge sections, irradiated in a lattice fashion or in one or more lines around the edge sections, or irradiated in an island or intermittent fashion.

Although not necessary according to. the invention, when one of the resin sheets is a material with low adhesion such as a fluorine-containing material, the bonding may be formed between the resin sheets by electron beam radiation after laying an adhesion-promoting layer between each of the resin sheets.

The irradiation conditions for the electron beam need only be sufficient to generate radicals on the multilayered resin sheet surfaces and they will depend on the types and thicknesses of the resin sheets, but the irradiation will generally be conducted at least 10 keV of an acceleration electric field, and at least 10 kGy of a dose. It is preferably 50-200 keV of an acceleration electric field, and 30-1000 kGy of a dose.

The size of the chemical bonding formed between the resin sheets by the invention can be evaluated by an adhesion/peel test of the resin sheets of the resulting multilayer laminated body. Instances of a specific method are described in the examples.

According to the invention it has been confirmed by the results of adhesion/peel testing of multilayer laminated bodies that chemical bonding is formed between different resin sheets even when resin sheets of fluorine-based materials are included.

Although chemical bonding is formed by electron beam radiation between the resin sheets constituting the multilayer laminated body of the invention, separate thin or thick resin sheets may also be bonded by a method other than electron beam radiation, or simply laminated, or laminated and attached by a mechanical method, onto a multilayer laminated body having such chemical bonding produced by electron beam radiation.

When the multilayer laminated body is used on the surface of a liquid crystal panel in a liquid crystal display device, for example, the multilayered films of the multilayer laminated body are not only mechanically attached by the chemical bonding formed in the multilayer laminated body, but the edge regions are also bonded into a hermetically sealed structure, so that moisture and the like from the surrounding atmosphere cannot penetrate into the multilayer laminated body.

### EXAMPLES

### Example 1

A 15 cm-square polyurethane (Morthane L429.71, product of Morton International) sheet with a thickness of approximately 0.2 mm was fabricated using a hot press (Mini Test Press 10, product of Toyo Seiki Kogyo) at 180° C., with a 0.2 mm thickness guide. Two thus fabricated sheets were prepared, an equally 15 cm-square THV200G (terpolymer of tetrafluoroethylene, hexafluoropropylene and vinylidene fluoride, product of Taioxin Co.) film with a thickness of 0.05 mm was sandwiched between them, and a silicone-treated PET film was inserted between each of the films at 25 mm from one edge as an insertion lip for the subsequent adhesion test, to prepare a sample. The sample was then pressed at 180° C. for 3 minutes using a hot press, and then cooled to room temperature.

The thus fabricated sample was irradiated with a 20 Mrad electron beam at an accelerating voltage of 250 kV at room temperature with nitrogen replacement (oxygen concentration: approximately, 200 ppm) . The electron beam apparatus used was. a System 7824 Electron Curtain by Energy Science, Inc., and the line speed was 2 m/min.

Next, the obtained sample was cut into three test strips of 25 mm width to test the adhesive properties of the irradiated sample by ASTM D-1876, known as the T-peel test. A Tensometer 10. (product of Monsanto Co.) was used for measurement of the peel strength with a crosshead speed of 300 nm/min, and the average values are shown in Table 1.

### Example 2

The same procedure was repeated for Example 2, except that a 0.05 mm-thick film of THV500G (product of Dyneon Co.) was used instead of the THV200 film of Example 1. The test results are shown in Table 1.

### Example 3

The same procedure was repeated for Example 3, except that a 0.1 mm-thick film of ethylene-tetrafluoroethylene copolymer (ETFE) (ET-6235J, product of Dyneon Co.) was used instead of the THV200 film of Example 1. The test results are shown in Table 1.

### Example 4

The same procedure was repeated for Example 4, except that a 0.2 mm-thick film of ethylene-vinyl acetate copolymer (EVA) (NUC-8450, product of Nihon Unicar Co., Ltd.) was used instead of the urethane film of Example 1. The test results are shown in Table 1.

### Example 5

The same procedure was repeated for Example 5, except that a 0.2 mm-thick film of ethylene-propylene-diene monomer copolymer (EPDM) (EP-24, product of Japan Synthetic Rubber Co. Ltd.) was used instead of the urethane film of Example 2. The test results are shown in Table 1.

### Example 6

The same procedure was repeated for Example 6, except that 1 mm-thick nylon-6 fibers (680 denier) were used as the base material instead of the urethane film of Example 2. The test results are shown in Table 1.

### Comparative Examples 1-6

The corresponding procedures for Examples 1 to 6 were repeated for Comparative Examples 1 to 6, but without electron beam radiation. The test results are shown in Table 1.

TABLE 1

| | | | Irradiation | Peel |
|---|---|---|---|---|
| Example/Comp. | Fluorine | | dose | strength |
| Ex. | polymer | Base material | (Mrad) | (g/25 mm) |
| Example 1 | THV200 | polyurethane | 20 | 350 |
| Example 2 | THV500 | polyurethane | 20 | 80 |
| Example 3 | ETFE | polyurethane | 20 | 117 |
| Example 4 | THV200 | EVA | 20 | 1500 |
| Example 5 | THV500 | EPDM | 20 | 800 |
| Example 6 | THV500 | Nylon-6 fiber | 20 | 660 |
| Comp. Ex. 1 | THV200 | polyurethane | 0 | 228 |
| Comp. Ex. 2 | THV500 | polyurethane | 0 | 50 |
| Comp. Ex. 3 | ETFE | polyurethane | 0 | 45 |
| Comp. Ex. 4 | THV200 | EVA | 0 | 51 |
| Comp. Ex. 5 | THV500 | EPDM | 0 | 55 |
| Comp. Ex. 6 | THV500 | Nylon-6 fiber | 0 | 30 |

As shown by the data in Table 1, electron beam radiation improved the adhesion between the fluorine polymers and base materials, compared to the samples of Comparative Examples 1 to 6 which were not irradiated with an electron beam.

### Example 7

A fluorine rubber (FKM) (FE-5830Q, product of Dyneon Co.), which is a terpolymer of tetrafluoroethylene, hexafluoropropylene and vinylidene fluoride, was kneaded with the components listed in Table 2 using an ordinary roll. The values for the component contents are all parts by weight with respect to 100 parts by weight (phr) of the fluorine rubber. A 15 cm-square sheet with an approximate thickness of 1 mm was fabricated by pressing at 170° C. for 10 minutes, and then secondary vulcanization was carried out at 230° C. for 24 hours. Two of the sheets fabricated in this manner were used as base materials for sandwiching of an equally 15 cm-square THV500G film with a 0.05 mm thickness, to prepare a sample. The sample preparation, electron beam irradiation and adhesion test were carried out in the same manner as Example 1. The test results are shown in Table 3.

### Example 8

The same procedure was repeated for Example 8, except that a 0.1 mm-thick film of ethylene-tetrafluoroethylene copolymer (ETFE) (ET-6235J, product of Dyneon Co.) was used instead of the THV500 film of Example 7. The test results are shown in Table 3.

### Comparative Example 7, 8

The corresponding procedures for Examples 7 and 8 were repeated for Comparative Examples 7 and 8, but without electron beam radiation. The test results are shown in Table 3.

TABLE 2

| | | | Parts by |
|---|---|---|---|
| | | | weight |
| Components | Chemical name | Manufacturer | (phr) |
| FE-5830Q | Fluorine rubber | Dyneon | 100 |
| N-990 | Carbon black | Cancarb | 30 |
| MgO | Magnesium oxide | Kyowa Chemical | 3 |
| | | Industries, Inc. | |
| Calbit | Calcium hydroxide | Ohmi Chemicals, Inc. | 6 |

TABLE 3

| | | | Irradiation | Peel |
|---|---|---|---|---|
| Example/Comp. | Fluorine | Base | dose | strength |
| Ex. | polymer | material | (Mrad) | (g/25 mm) |
| Example 7 | THV500 | FKM | 20 | 1275 |
| Example 8 | ETFE | FKM | 20 | 42 |
| Comp. Ex. 7 | THV500 | FKM | 0 | 30 |
| Comp. Ex. 8 | ETFE | FKM | 0 | 30 |

As shown by the data in Table 3, electron beam radiation improved the adhesion between the vulcanized fluorine rubber, fluorine polymers and base materials, compared to the samples of Comparative Examples 7 and 8 which were not irradiated with an electron beam.

### Example 9

The same procedure was repeated for Example 9, except that a 0.025 mm-thick film of polyethylene naphthalate (PEN) (Teonex film Qo1, product of Teijin Co., Ltd.) was used instead of the urethane film of Example 1, and the crosshead speed in the peel test was 10 mm/min. The test results are shown in Table 4.

### Examples 10-12

The same procedure was repeated for Examples 10 to 12 as in Example 9, except that the electron beam radiation dose was changed. The test results are shown in Table 4.

### Comparative Example 9

The corresponding procedure for Example 9 was repeated for Comparative Example 9, but without electron beam radiation. The test results are shown in Table 4.

TABLE 4

| | | | Irradiation | Peel |
|---|---|---|---|---|
| Example/Comp. | Fluorine | Base | dose | strength |
| Ex. | polymer | material | (Mrad) | (g/25 mm) |
| Example 9 | THV200 | PEN | 20 | 565 |
| Example 10 | THV200 | PEN | 15 | 475 |
| Example 11 | THV200 | PEN | 10 | 417 |
| Example 12 | THV200 | PEN | 5 | 182 |
| Comp. Ex. 9 | THV200 | PEN | 0 | 18 |

### Example 13

After using a T-die and a 50 mm single-screw extruder (product of Research Laboratory of Plastics Technology Co., Ltd.) for extrusion of THV200 to a thickness of 0.05 mm onto a PET film (A) with a thickness of 0.05 mm and passage through a nip roll, a PET film (B) of the same 0.05 mm thickness was further laminated onto the THV200 side with a nip roll, and both sides were cut for a laminated film width of 300 mm to fabricate a three-layer film.

The laminated film sample fabricated in this manner was cut into a 15 cm square and continuously irradiated with an electron beam at 20 Mrad with an accelerating voltage of 250 KV, in the same manner as Example 1, after which a test strip was prepared from the irradiated sample in the same manner as Example 1 to test the adhesive performance of the irradiated sample. Table 5 shows the adhesive forces at “interface A” (PET film A-THV200) and at “interface B” (THV200-PET film B) measured for each sample from the direction of electron beam radiation, in order to determine the adhesive force between each of the layers, and the average values are listed in Table 5.

### Comparative Example 10

Comparative Example 10 was carried out in the same manner as Example 13 but without electron beam radiation. The test results are shown in Table 5.

TABLE 5

| | | | | Peel strength | |
|---|---|---|---|---|---|
| | | | Irradiation | (g/25 mm) | |
| Example/ | Fluorine | Base | dose | Interface | Interface |
| Comp. Ex. | polymer | material | (Mrad) | A | B |
| Example 13 | THV200 | PET | 20 | 900 | 321 |
| Comp. Ex. 10 | THV200 | PET | 0 | 85 | 58 |

Example 14 demonstrates that electron beam radiation in a multilayer film reaches to the interface on the opposite side to improve adhesion.

### Example 14

An A4 size was cut out from a multilayer film (DFEF by 3M Co., over 40 layers, 100 μm thickness), and the entire surface of the multilayer film was irradiated with an electron beam under different conditions. The electron beam radiation conditions were an accelerating voltage of 200 kV, a dose of 5-15 Mrads (non-irradiated, 5 Mrads, 15 Mrads) and a nitrogen atmosphere (oxygen concentration: approximately 50 ppm).

After the electron beam radiation, a strip was cut out with a width of 25 mm and a length of 30 cm, adhesive tape was attached to both sides at one end, and the tape was used for forced interlayer peeling of the multilayer film to approximately 5 cm to prepare a “grip section” with an approximate length of 5 cm. The multilayer film strip was then placed on a tensile tester and the “grip section” was stretched while measuring the T-die peel strength. The peel rate was 300 mm.

The relationship between the electron beam radiation conditions and the peel strength was as follows. The values were the same at all sections of all interlayers of the multilayer film.

| Electron beam intensity | Peel strength |
|---|---|
| Non-irradiated | 49.98 g/25 mm |
| 5 Mrads | 376.38 g/25 mm |
| 15 Mrads | 391.68 g/25 mm |

Even with over 40 layers in the multilayer film, it was confirmed that electron beam radiation increased the peel strength between the layers of the multilayer film at all sections between all the layers.

Comparative measurements of the optical properties of the multilayer film were also made before and after the electron beam radiation, but the only differences observed were within the range of error, and therefore substantially no problem was presented.

The DFEF multilayer film by 3M Co. is a type of film which is built into liquid crystal monitors and the like to increase screen brightness through reutilization of light by polarization and reflection. According to the present invention, electron beam radiation of the multilayer film allowed peeling between the films of the multilayer film to be eliminated without reducing the optical properties, thus increasing the handleability.

### Effect of the Invention

According to the present invention it is possible to impart sufficient bonding between resin sheets of multilayer sheets by the simple process of electron beam radiation, to thus provide improved handleability and other advantages.

We claim:

1. A multilayer laminated body comprising three or more layers of laminated resin sheets made of at least two different materials, the multilayer laminated body being characterized by having chemical bonding formed between said three or more layers by electron beam radiation.

2. The multilayer laminated body according to claim 1, wherein said laminated body is formed by laminating 40 or more layers of resin sheets and having chemical bonding formed between said 40 or more layers by electron beam radiation.

3. The multilayer laminated body according to claim 1 or 2, wherein at least one of said resin sheet is a resin sheet of a material having a low surface energy of not more than 45 mJ/m².

4. The multilayer laminated body according to any one of claims 1 to 3, wherein at least one of said resin sheets is a fluorine-containing material sheet.

5. The multilayer laminated body according to any one of claims 1 to 4, wherein at least one of said resin sheet is a silicone resin sheet.

6. The multilayer laminated body according to any one of claims 1 to 5, wherein at least one of said resin sheets is a sheet made of at least one type of resin selected from the group consisting of polyolefin-based resins, polycarbonate resins, polyester resins, urethane resins and acrylic resins.

7. The multilayer laminated body according to any one of claims 1 to 6, wherein said laminated body is an optical sheet formed by laminating resin sheets with at least two different refractive indexes.

8. The multilayer laminated body according to claim 7, wherein said optical sheet is a reflective sheet, non-reflective sheet or polarizing sheet.

9. A process for production of a multilayer laminated body, characterized by radiating an electron beam onto a laminated body comprising three or more laminated layers of resin sheets made of at least two different materials, to form chemical bonding between the three or more layers.
